(19) United States
(12) Patent Application Publication
(10) Pub. No.: US 2026/0236830 A1
(43) Pub. Date: Aug. 13, 2026

(54) ADAPTIVE HIBERNATION MECHANISM FOR ARTIFICIAL INTELLIGENCE MODELS ON EDGE DEVICES

(71) Applicant: Red Hat, Inc., Raleigh, NC (US)

(72) Inventors: Leigh Griffin, Waterford (IE); Dimitri Saridakis, Waterford (IE)

(21) Appl. No.: 19/052,008

(22) Filed: Feb. 12, 2025

(51) Int. Cl. G06N 20/00; G06F 16/903

(52) U.S. Cl. CPC G06N 20/00; G06F 16/90335

(57) ABSTRACT

Aspects of the present disclosure relate to an adaptive hibernation mechanism for AI models on edge devices. More specifically, a processing device monitors operational parameters associated with a computing device on which an artificial intelligence (AI) model is deployed. The processing device adjusts a component associated with the AI model based on the monitored operational parameters. The processing device processes data with the AI model with the adjusted component.

### TECHNICAL FIELD

Aspects of the present disclosure relate to artificial intelligence (AI) models, and more particularly, to an adaptive hibernation mechanism for AI models on edge devices.

### BACKGROUND

AI is a field of computer science that encompasses the development of systems capable of performing tasks that typically require human intelligence. Machine learning is a branch of artificial intelligence focused on developing algorithms and models that allow computers to learn from data and make predictions or decisions without being explicitly programmed. Machine learning models are the foundational building blocks of machine learning, representing mathematical and computational frameworks used to extract patterns and insights from data. By combining advanced machine learning techniques with enormous datasets, large language models harness data-driven approaches to achieve highly sophisticated language understanding and generation capabilities. AI models include machine learning models, large language models, and other types of models such as those based on neural networks, genetic algorithms, expert systems, Bayesian networks, reinforcement learning, decision trees, or combination thereof.

Edge computing may refer to a distributed computing model that brings computation and data storage closer to sources of data. Edge computing may push computations physically closer to a source of data to reduce latency. Edge computing may also reduce reliance on a cloud infrastructure.

### BRIEF DESCRIPTION OF THE DRAWINGS

The described aspects and the advantages thereof may best be understood by reference to the following description taken in conjunction with the accompanying drawings. These drawings in no way limit any changes in form and detail that may be made to the described aspects by one skilled in the art without departing from the spirit and scope of the described aspects.

FIG. 1 is a block diagram that illustrates an example system for an adaptive hibernation mechanism for AI models on computing devices in accordance with some aspects of the present disclosure.

FIG. 2 is a block diagram that illustrates hibernation of a layer of an AI model in accordance with some aspects of the present disclosure

FIG. 3 is a block diagram that illustrates an example system for an adaptive hibernation mechanism for AI models on edge devices in accordance with some aspects of the present disclosure

FIG. 4 is a flow diagram of a method for an adaptive hibernation mechanism for AI models on edge devices in accordance with some aspects of the present disclosure.

FIG. 5 is a block diagram of an example of a computer system that may perform one or more of the operations described herein in accordance with some aspects of the present disclosure.

### DETAILED DESCRIPTION

AI models (e.g., a machine learning model (ML) model such as a neural network) are increasingly being used to solve problems and to provide functionality to entities and/or users. For example, a computing device may execute an AI model to make decisions or predictions. However, using an AI model may consume a relatively large amount of power of a computing device that executes the AI model. For instance, processes pertaining to training and retraining an AI model and using the AI model for inference may entail performing a relatively large amount of computations which may consume a relatively large amount of power. Certain computing devices (e.g., edge devices) may be power constrained (e.g., may have a limited battery life). Executing AI models on such computing devices may lead to a rapid depletion of batteries of the computing devices, which may reduce an operational longevity and effectiveness of such computing devices.

The present disclosure addresses the above-noted and other deficiencies by using a processing device to perform an adaptive hibernation mechanism for AI models on edge devices (or other computing devices). For example, an edge device having an AI model deployed thereon may monitor operational parameters of the edge device, such as a battery level of the edge device. The edge device may selectively adjust a component of the AI model based on the monitored operational parameters. For instance, the edge device may freeze one or more layers of the AI model for (re)training when the AI model is neural network, the edge device may change a numerical precision of computations (e.g., 32-bit floating point to 16-bit floating point) performed by the AI model, and/or the edge device may deactivate certain components (e.g., a preprocessing component) of the AI model. The computing device may process data using the AI model that has the adjusted component. For example, the computing device may (re)train the AI model with the frozen layer using the data, the computing device may process the data using the AI model with the changed numerical precision, and/or the computing device may use the AI model to process the data without preprocessing the data. The computing device may also continue to monitor the operational parameters of the computing device. The computing device may revert the adjustment to the component of the AI model when suitable conditions exist. For example, when a battery level of the computing device is above a threshold level, the computing device may unfreeze the one or more layers of the AI model, revert the numerical precision back to the original numerical precision, and/or reactivate the certain components of the AI model. As such, the present disclosure reduces power consumption of the edge device while still providing an acceptable level of functionality of the AI model.

In an example, a processing device monitors operational parameters associated with a computing device on which an artificial intelligence (AI) model is deployed. The processing device adjusts a component associated with the AI model based on the monitored operational parameters. The processing device processes data with the AI model with the adjusted component.

The technologies described herein may be associated with various advantages. For example, vis-à-vis adjusting a component associated with the AI model (e.g., freezing a layer for training) based on operational parameters (e.g., a power consumption, historical usage patterns, etc.), a computing device may reduce usage of computational resources of the computing device and/or reduce power usage of the computing device while still providing at least a subset of functionality associated with the AI model. For instance, the AI model may continue to provide inference functionality when the component is adjusted, but may not (re)train all layers of the AI model.

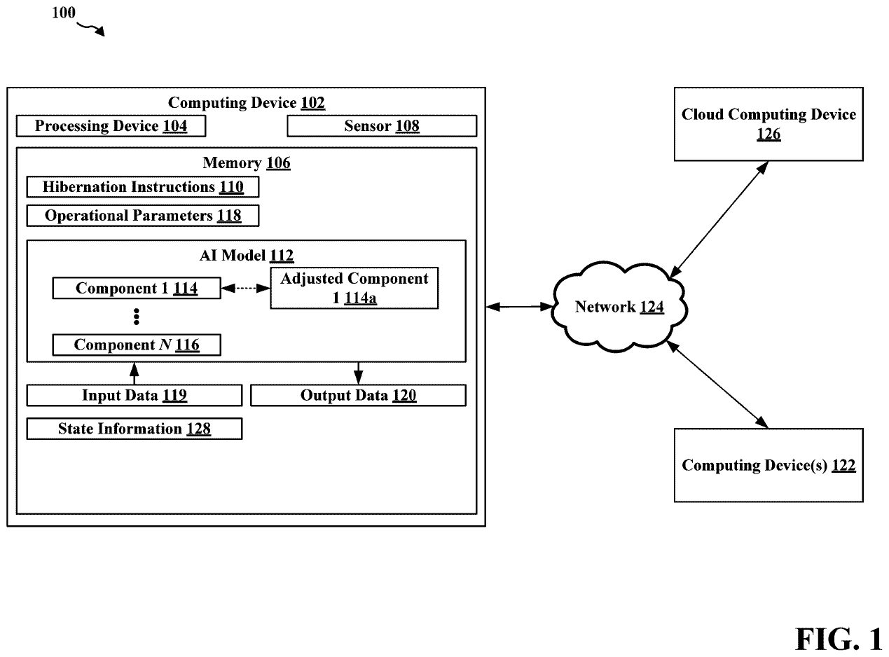

FIG. 1 is a block diagram 100 that illustrates an example system for an adaptive hibernation mechanism for AI models on computing devices in accordance with some aspects of the present disclosure. The system includes a computing device 102. In an example, the computing device 102 may be an edge device or an Internet-of-Things (IoT) device. An edge device may refer to a computing device that collects and processes data close to a source of the data. An IoT device may refer to a device that can connect to the Internet and exchange data with other devices. In an example, an edge device and/or an IoT device may be or include a sensor, a camera, a point of sale system, and/or a barcode scanner. In another example, the computing device 102 may be or include a desktop computing device, a laptop computing device, a smartphone, a tablet computing device, a server computing device, a gaming console, a wearable computing device, and/or an extended reality (XR) computing device. In yet another example, the computing device 102 may be or include the computer system 500 (or a portion thereof). In some aspects, the computing device 102 may be power constrained, that is, the computing device 102 may be powered by a battery that depletes over time as the computing device 102 operates. For instance, the computing device 102 may include a battery that may be recharged via solar power. In some aspects, the computing device 102 may not be power constrained. For instance, the computing device 102 may be powered from power from an electrical grid.

The computing device 102 includes a processing device 104 (e.g., a processor, a central processing unit (CPU), a graphics processing unit (GPU), a system on a chip (SoC), an application-specific integrated circuit (ASIC), etc.). The computing device 102 may include memory 106 (e.g., random access memory (RAM)). The computing device 102 may include other elements not depicted in FIG. 1. For instance, the computing device 102 may include storage devices (e.g., a hard-disk drive (HDD) a solid-state drive (SSD), etc.), input devices (e.g., a keyboard, a touchscreen, a mouse, a microphone, etc.), output devices (e.g., a touchscreen, a display, a speaker, etc.), a network interface device, etc. A storage device may include a persistent storage that is capable of storing data. A persistent storage may be a local storage unit or a remote storage unit. Persistent storage may be a magnetic storage unit, optical storage unit, solid state storage unit, electronic storage units (main memory), or similar storage unit. Persistent storage may also be a monolithic/single device or a distributed set of devices.

The computing device 102 may include a sensor 108. In an example, the sensor 108 may be or include a temperature sensor, a pressure sensor, a humidity sensor, a proximity sensor, a light sensor, a position sensor, a proximity sensor, a level sensor, a flow sensor, a color sensor, a chemical sensor, a force sensor, a sound sensor, a non-contact sensor, an infrared sensor, an ultrasonic sensor, and/or a magnetic sensor. The sensor 108 may be configured to collect/gather/generate sensor data from an environment in which the computing device 102 is deployed.

The memory 106 may store hibernation instructions 110. The hibernation instructions 110, when executed by the processing device 104, may cause the processing device 104 to implement functionality pertaining to an adaptive hibernation mechanism for AI models as described herein. In some aspects, the hibernation instructions 110 may be included in a monitoring application (not depicted in FIG. 1) stored in the memory 106 and executed by the processing device 104, where the processing device 104 executes the monitoring application to implement functionality pertaining to an adaptive hibernation mechanism for AI models as described herein.

The computing device 102 may have an AI model 112 deployed thereon. For instance, the memory 106 may store the AI model 112. In an example, the AI model 112 may be or include a machine learning (ML) model. For instance, the AI model 112 may be or include a model associated with supervised learning, unsupervised learning, semi-supervised learning, and/or reinforcement learning. In an example, the AI model 112 may be or include a neural network (e.g., a deep neural network), a decision tree, a support-vector machine, a regression model, a Bayesian network, a Gaussian process, etc. In an example, the AI model 112 may include learned parameters, where values of the learned parameters are influenced by a (re)training process of the AI model 112. In general, the AI model 112 may be configured to receive, as input, first data and output, based on the data and parameters of the AI model 112, second data. For instance, the AI model 112 may be configured to classify the first data, make a prediction based on the first data, etc.

The AI model 112 may be associated with a first component 114 and an Nth component 116, where N is a positive integer greater than one. The first component 114 and the Nth component 116 may collectively be referred to as “a plurality of components 114-116.” As used herein, the term “component” with respect to an AI model may refer to a part of the AI model, a feature of the AI model, or a process or a service used by the AI model.

In an example, the plurality of components 114-116 of the AI model 112 may include learned parameters of the AI model 112. For instance, the plurality of components 114-116 may include layer(s) and/or bias(es) of a neural network. In another example, the plurality of components 114-116 may include a numerical precision (e.g., 16-bit, 32-bit float, 64-bit float, etc.) of computations of the AI model 112 when the AI model 112 is executed by the processing device 104. In a further example, the plurality of components 114-116 may include a preprocessing component of the AI model 112, a prompt engineering component of the AI model 112, a training component of the AI model 112, and/or an inference component of the AI model 112. The preprocessing component of the AI model 112 may be configured to clean, transform, and/or organize data such that the AI model 112 may process the data. The prompt engineering component of the AI model 112 may be configured to design and refine inputs to the AI model to produce a desired output. The training component of the AI model 112 may be configured to update learned parameters (e.g., values of weights, values of biases, etc.) of the AI model 112 during a training process. The inference component of the AI model 112 may be configured to use the (trained) AI model 112 to make predictions and/or decisions based on new data provided to the AI model 112.

Each of the plurality of components 114-116 of the AI model 112 may be associated with resource usage (e.g., usage of processor clock cycles, usage of an amount of memory, usage of an amount of power, etc.). The computing device 102 (or another computing device) may determine resource usage of each of the plurality of components 114-116 of the AI model 112. For instance, the computing device 102 (or another computing device) may determine that the first component 114 (e.g., a preprocessing component of the AI model 112) is associated with a first power consumption and the Nth component 116 (e.g., a layer in a neural network) is associated with a second power consumption.

The computing device 102 may monitor operational parameters 118 associated with the computing device 102 as the computing device 102 operates. In an example, the operational parameters 118 may be or include a battery level of the computing device 102, memory usage of the computing device 102, processor usage of the computing device 102, and/or historical usage patterns of the computing device 102. In an example, the historical usage patterns of the computing device 102 may indicate that the AI model 112 is typically used to process data during a first time period (e.g., during the day), whereas the AI model 112 is typically not used to process data during a second time period (e.g., during the night). In some aspects, the computing device 102 may execute a monitoring application (not depicted in FIG. 1) to monitor the operational parameters 118.

The computing device 102 may adjust component(s) in the plurality of components 114-116 of the AI model 112 based on the operational parameters 118 associated with the computing device 102. For instance, the computing device may adjust the first component 114 such that the first component 114 becomes/is associated with a first adjusted component 114a. Adjusting a component in the plurality of components 114-116 may refer to deactivating the component and/or changing a mode of operation of the component. In a specific example, the operational parameters 118 may indicate that a battery level of the computing device 102 is below a threshold level, and adjusting the component may include deactivating the component. In some aspects, deactivating a component may include suspending a service associated with the AI model 112, suspending a process associated with the AI model 112, moving data stored in the memory 106 to persistent storage, etc. In some aspects, adjusting the component(s) of the plurality of components 114-116 may additionally be based on the power consumption(s) of the component(s).

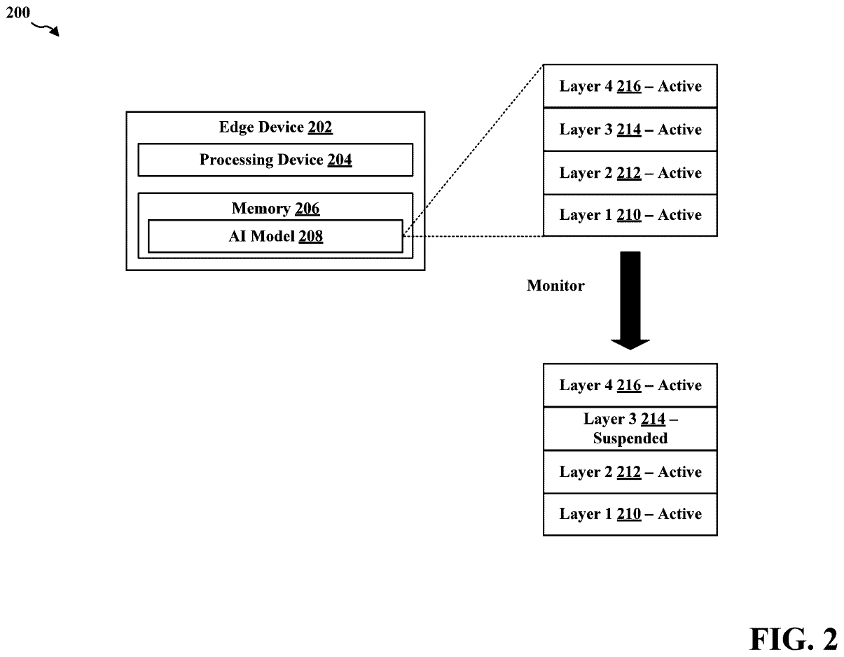

In one example, the AI model 112 may be a neural network that includes a plurality of layers, and the first component 114 may include or be associated with a layer of the neural network. The first adjusted component 114a may be associated with freezing the layer for (re)training purposes (explained in greater detail below in the description of FIG. 2). Freezing the layer for training purposes may reduce a computation load on the computing device 102 and/or may reduce power consumption of the computing device 102.

In another example, the first component 114 may be associated with a first numerical precision (e.g., 32-bit floating point) of computations of the AI model 112. In the example, the first adjusted component 114a may be associated with a second numerical precision (e.g., 16-bit floating point) of computations of the AI model 112. Changing the numerical precision of computations of the AI model 112 may reduce memory usage of the AI model 112 and/or reduce power consumption of the computing device 102.

In a further example, the first component 114 may be a part or a process associated with the AI model 112. In the example, the first adjusted component 114a may be associated with the part or the process being deactivated. Deactivating the part of the process of the AI model 112 may lower power consumption of the AI model 112 by minimizing unnecessary computations.

The computing device 102 may process data (e.g., input data 119) with the AI model 112 that has the first adjusted component 114a. In one example, the computing device 102 may (re)train the AI model 112 with a layer frozen (described in greater detail below) based on the input data 119. In another example, the computing device 102 may (re)train the AI model 112 or perform inference with the AI model 112 using the second numerical precision described above. For instance, the computing device 102 may perform inference with the AI model 112 based on the input data 119 to obtain output data 120 (e.g., a classification or a prediction). In a further example, the computing device 102 may (re)train the AI model 112 or perform inference with the AI model 112 while the part or the process of the AI model is deactivated. For example, the computing device 102 may perform inference with the AI model 112 using the input data 119 without preprocessing the input data 119.

In some aspects, the input data 119 may be or include sensor data generated/gathered/collected by the sensor 108 of the computing device 102. In such aspects, the computing device 102 may process the sensor data with the AI model 112 with the first adjusted component 114a. In such aspects, the output data 120 may be a prediction and/or a decision based on the input data 119 and parameters of the AI model 112.

In some aspects, the input data 119 may be or include a query that is to be input to the AI model 112. In one example, the computing device 102 may generate the query based on sensor data generated/gathered/collected by the sensor 108. In another example, the computing device 102 may receive the query (or a portion thereof) from computing device(s) 122 by way of a network 124. In an example, the computing device(s) may include edge device(s). In yet another example, the computing device 102 may receive the query (or a portion thereof) from a cloud computing device 126. In an example, the network 124 may be or include a public network (e.g., the Internet), a private network (e.g., a local area network (LAN) or wide area network (WAN)), or a combination thereof. In one example, the network 124 may include a wired or a wireless infrastructure, which may be provided by one or more wireless communications systems, such as a WiFi™ hotspot connected with the network 124 and/or a wireless carrier system that can be implemented using various data processing equipment, communication towers (e.g., cell towers), etc. The network 124 may carry communications (e.g., data, message, packets, frames, etc.) between the computing device 102, the computing device(s) 122, and/or the cloud computing device 126. The computing device 102 may process the query using the AI model 112 with the first adjusted component 114a.

In some aspects, the computing device 102 may classify a complexity of the query and the computing device 102 may adjust a component in the plurality of components 114-116 based on the complexity of the query. For instance, the computing device 102 may determine one or more components in the plurality of components 114-116 that are to be used (or not used) to process the query. In a specific example, the first component 114 may be a preprocessing component and the query may be in a format that does not require the query to be preprocessed. As such, the computing device 102 may deactivate the first component 114 and the computing device 102 may process the query (e.g., perform inference using the query) using the AI model 112 that has the first component 114 deactivated.

In some aspects, the computing device 102 may determine that the query is to be offloaded to the cloud computing device 126 based on the operational parameters 118 and/or the complexity of the query. For instance, the computing device 102 may determine that executing the query with the AI model 112 would cause a battery level of the computing device 102 to drop below a threshold level or that executing the query with the AI model 112 would cause a computational load on the computing device 102 to exceed a threshold load. In such aspects, the computing device 102 may transmit the query, via the network 124, to the cloud computing device 126. The cloud computing device 126 may process the query (e.g., using an AI model similar to the AI model 112). The cloud computing device 126 may transmit results of the query to the computing device 102 via the network 124.

In some aspects, the computing device 102 may adjust the first component 114 of the AI model 112 based on a service-level agreement (SLA). An SLA may refer to an agreement between a service provider and an entity (e.g., an organization, such as a corporation) that utilizes services of the service provider that specifies the services the service provider will provide to the entity and the standards that the service provider is obligated to meet. For instance, the SLA may provide for an uptime of services that are provided by the service provider to the entity. In an example, the computing device 102 may deactivate the first component 114 if deactivating the first component 114 does not cause the SLA to be violated.

The computing device 102 may continue to monitor the operational parameters 118 associated with the computing device 102 subsequent to processing the data (e.g., input data 119) with the AI model 112 that has the first adjusted component 114a. The computing device 102 may revert the adjustment to the first component 114 (i.e., revert the first adjusted component 114a back to the first component 114) based on the subsequent monitoring of the operational parameters 118. For example, reverting the adjustment may be based on a battery level of the computing device, a complexity of a (second) query to be processed by the AI model 112, and/or historical usage patterns of the computing device 102. In a specific example, the computing device 102 may determine, based on the monitoring, that a battery level of the computing device 102 has risen above a threshold level (e.g., due to the battery charging via solar power), and the computing device 102 may reactivate the first component 114 based on the battery level exceeding the threshold level.

In some aspects, prior to or concurrently with adjusting the first component 114 of the AI model 112, the computing device 102 may store state information 128 associated with the first component 114. The state information 128 may include a collection of variables used to describe a state of the first component 114. The computing device 102 may revert the adjustment to the first component 114 based on the state information 128.

Although the functionality pertaining to adaptive hibernation has primarily been described with respect to AI models, it is to be understood that the concepts described herein may apply to ML models, AI models, or both ML models and AI models.

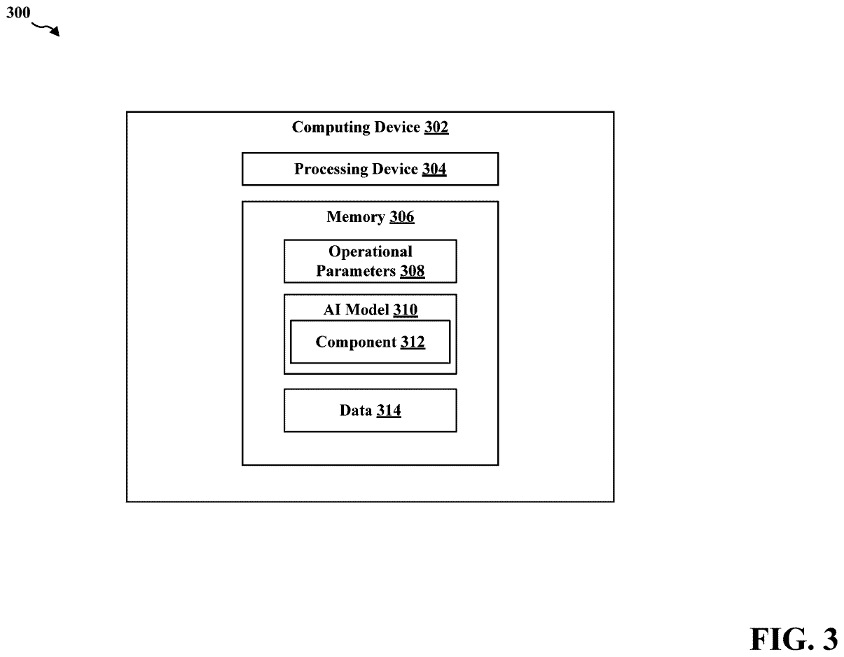

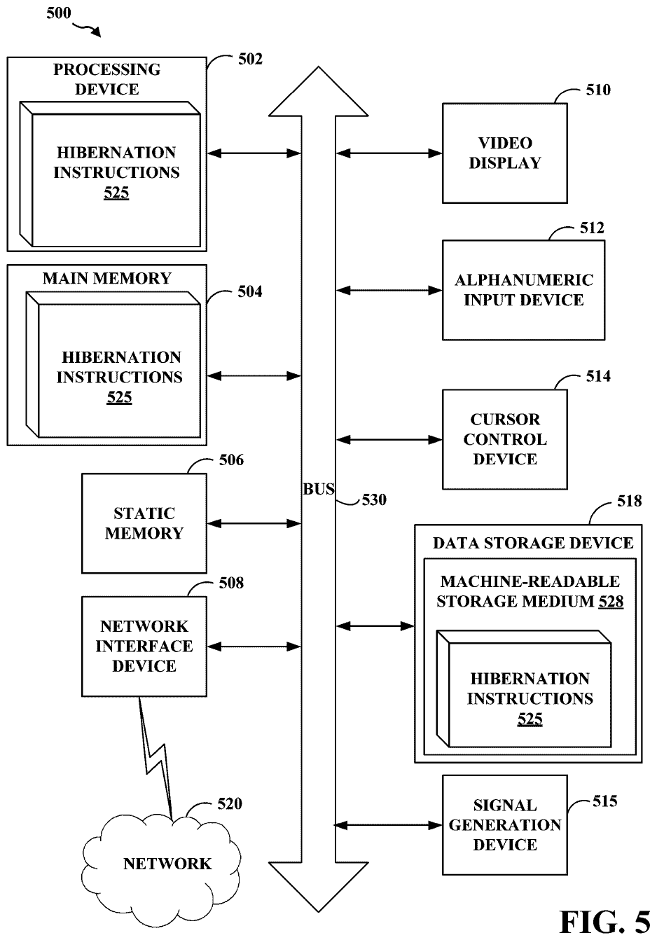

FIG. 2 is a block diagram 200 that illustrates hibernation of a layer of an AI model in accordance with some aspects of the present disclosure. The block diagram 200 depicts an edge device 202. In an example, the edge device 202 may be or include the computing device 102 in FIG. 1, the computing device 302 in FIG. 3, or the computer system 500 in FIG. 5. The edge device 202 includes a processing device 204 and memory 206. The memory 206 may store an AI model 208. In an example, the AI model 208 may be or include the AI model 112.

In an example, the AI model 208 is a neural network that includes a plurality of layers. The plurality of layers may include a first layer 210, a second layer 212, a third layer 214, and a fourth layer 216. In an example, each of the first layer 210, the second layer 212, the third layer 214, and the fourth layer 216 may include node(s), where node(s) in different layers are connected by edge(s) having associated weight(s), where values of the weight(s) may be influenced by a (re)training process for the neural network. For example, first node(s) in the first layer 210 may be connected to second node(s) in the second layer 212 by first edge(s) associated with first weight(s), the second node(s) in the second layer 212 may be connected to third node(s) in the third layer 214 by second edge(s) associated with second weight(s), and the third node(s) in the third layer 214 may be connected to fourth node(s) in the fourth layer 216 by third edge(s) associated with third weight(s). Although the AI model 208 is depicted as including four layers, it is to be understood that the AI model 208 may include less than four layers or more than four layers.

In an example, each of the first layer 210, the second layer 212, the third layer 214, and the fourth layer 216 may initially be active. For instance, each of the first layer 210, the second layer 212, the third layer 214, and the fourth layer 216 may be available for (re)training based on training data provided to the edge device 202. For instance, following the example above, values of weights associated with the edges connecting the first layer 210, the second layer 212, the third layer 214, and the fourth layer 216 may be updated based on the (re)training process.

In an example, and as described above in the description of FIG. 1, the edge device 202 may monitor operational parameters of the edge device 202. For example, the edge device 202 may monitor a battery level of the edge device 202. In an example, the edge device 202 may determine that the battery level of the edge device 202 has dropped below a certain threshold level (e.g., 20% battery life). In order to conserve power, the edge device 202 may suspend (i.e., deactivate) the third layer 214 for (re)training purposes based on the battery level dropping below the certain threshold level. When the third layer 214 is suspended, the weight(s) associated with the third layer 214 (e.g., weight(s) associated with edge(s) connecting node(s) of the third layer 214 to node(s) of the second layer 212 and/or the fourth layer 216) may not be updated during a (re)training process for the AI model 208. Suspending a layer may alternatively be referred to as “freezing” a layer. In an example, the edge device 202 may obtain new training data subsequent to the third layer 214 being suspended. The edge device 202 may perform a (re)training process based on at least the new training data. The training process may change values of weight(s) associated with edge(s) connecting node(s) of the first layer 210 with node(s) of the second layer 212; however, the value(s) of the weight(s) associated with edge(s) connecting node(s) of the third layer 214 to node(s) of the second layer 212 and/or the fourth layer 216 may not be updated during the (re)training process due to the third layer 214 being suspended.

FIG. 3 is a block diagram 300 that illustrates an example system for an adaptive hibernation mechanism for AI models on edge devices in accordance with some aspects of the present disclosure. The system includes a computing device 302. The computing device 302 includes a processing device 304 and memory 306. The processing device 304 is operatively coupled to the memory 306 to monitor operational parameters 308 associated with the computing device 302 on which an artificial intelligence (AI) model 310 is deployed. The processing device 304 is operatively coupled to the memory 306 to adjust a component 312 associated with the AI model 310 based on the (monitored) operational parameters 308. The processing device 304 is operatively coupled to the memory 306 to process data 314 with the AI model 310 with the (adjusted) component 312.

The deployment of AI models on edge devices may introduce challenges. For instance, the challenges may include energy management due to limited battery life available to an edge device and computationally intensive characteristics associated with AI models. Continuous operation of AI models may lead to rapid depletion of batteries of edge devices, which may reduce operational longevity and effectiveness of the edge devices. Dynamically managing power consumption of AI models deployed on edge devices (for usage or (re)training) and allowing edge devices to enter a hibernation state to conserve power without compromising readiness and/or performance of the edge devices is an unsolved problem.

Aspects presented herein pertain to an adaptive hibernation mechanism for AI models on edge devices. The adaptive hibernation mechanism may also apply to other domains (i.e., non-edge devices) in order to reduce power and running costs of AI models. The adaptive hibernation mechanism described herein may optimize power consumption while maintaining model responsiveness and accuracy. Through intelligently managing an operational state of an AI model, the adaptive hibernation mechanism described herein may dynamically transition between active and hibernation states based on a number of criteria. In some aspects, the criteria may include or be associated with context-aware policies that consider battery level of a device, historical AI model usage patterns (e.g., to activate/deactivate an AI model at peak/off-peak times), and operational demands (i.e., domain specific operational demands).

In some aspects, the adaptive hibernation mechanism may include selectively deactivating components of an AI model, such as layers and/or processes that consume the most power, while preserving state information for rapid reactivation of the layers and/or the processes. The aforementioned selective deactivation may be achieved in a variety of manners which reduce computational load and power consumption of an edge device. In one example, the adaptive hibernation mechanism may freeze layer(s) of an AI model (i.e., layer freezing), that is, the adaptive hibernation mechanism may make specific layer(s) of the AI model non-trainable to reduce computational load and to speed up a (re)training (or an inference) process by not updating weights of specific layer(s). In another example, the adaptive hibernation mechanism may adjust numerical precession of computations (which may be referred to as precision scaling) of the AI model (e.g., from 32-bit floating point to 16-bit floating point) to reduce memory usage and computational power demand while maintaining an acceptable level of accuracy. In yet another example, the adaptive hibernation mechanism may dynamically turn off or reduce activity of certain parts of an AI model and/or computational processes (which may be referred to as activity gating) when the certain parts of the AI model and/or the computational processes are not needed in order to lower energy consumption by minimizing unnecessary computations. For instance, the adaptive hibernation mechanism may perform activity gating when an incoming query for the AI model is less complex to process than what the AI model is fully capable of processing.

In some aspects described herein, a lightweight monitoring agent may be utilized in conjunction with context aware policies in order to determine optimal timing for entering and exiting hibernation. The lightweight monitoring agent may classify a complexity of a query, thus allowing for greater cuts to layers of an AI model if warranted by a current operational state of an edge device. The lightweight monitoring agent may balance a complexity tradeoff with battery consumption on the edge device, potentially offloading the query to a cloud based model. This may provide for better performance. In some aspects described herein, the lightweight monitoring agent may take into account service level agreements (SLAs) to ensure that restart times of deactivated components of AI models are within acceptable boundaries, thus enabling an aggressive approach to which layer(s) of an AI model are targeted for hibernation.

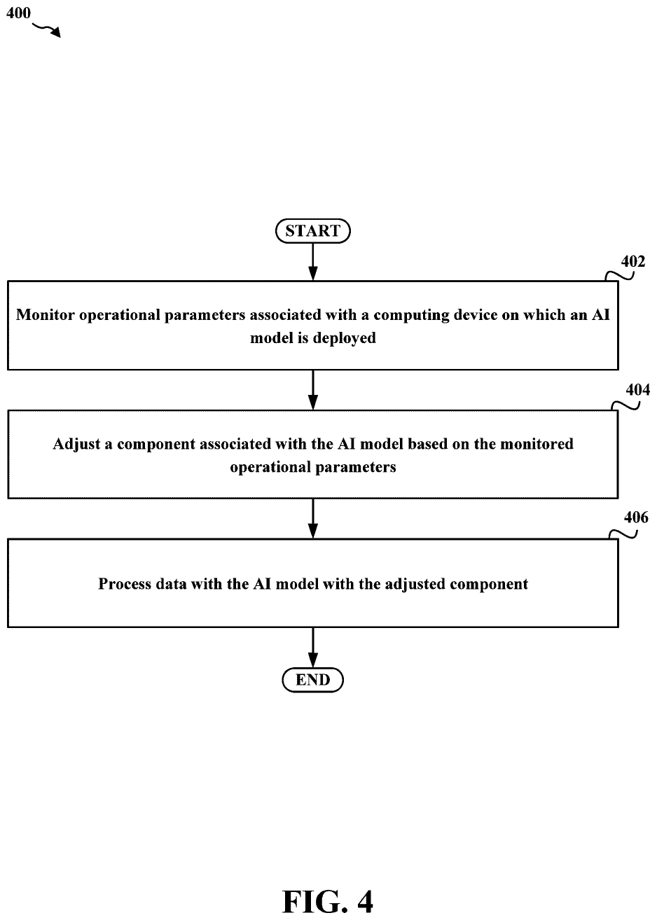

FIG. 4 is a flow diagram of a method 400 for an adaptive hibernation mechanism for AI models on edge devices in accordance with some aspects of the present disclosure. The method 400 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some aspects, the method 400 may be performed by a computing device (e.g., computing device 102 in FIG. 1, the computing device 302 in FIG. 3, etc.). In some aspects, the method 400 may be performed by an edge device (e.g., the edge device 202). In some aspects, the method 400 may be performed by the computer system 500. In some aspects, the method 400 may be performed by a processing device (e.g., the processing device 104 in FIG. 1, the processing device 204 in FIG. 2, the processing device 304 in FIG. 3, the processing device 502 in FIG. 5, etc.).

At block 402, a processing device monitors operational parameters associated with a computing device on which an AI model is deployed. In an example, the operational parameters may be or include the operational parameters 118, the computing device may be or include the computing device 102, and the AI model may be or include the AI model 112. In another example, the operational parameters may be or include the operational parameters 308, the computing device may be or include the computing device 302, and the AI model may be or include the AI model 310. In a further example, the AI model may be or include the AI model 208.

At block 404, the processing device adjusts a component associated with the AI model based on the monitored operational parameters. In an example, the component may be or include the first component 114. In another example, the component may be or include the component 312.

At block 406, the processing device processes data with the AI model with the adjusted component. In an example, the adjusted component may be or include the first adjusted component 114a. In an example, the data may be or include the input data 119. In another example, the data may be or include the data 314. In a further example, the data may be data used for inference or data used for (re)training of the AI model.

In some aspects, the AI model may include a plurality of layers, and adjusting the component associated with the AI model may include freezing a layer in the plurality of layers such that weights of the layer are not updated during a training process of the AI model. For example, the aforementioned aspect may correspond to the description of FIG. 2 above. For example, the plurality of layers may be or include the first layer 210, the second layer 212, the third layer 214, and the fourth layer 216.

In some aspects, adjusting the component associated with the AI model may include changing a numerical precision of the AI model from a first numerical precession to a second numerical precession, and processing the data with the AI model may include processing the data with the AI model using the second numerical precision. For example, the first component 114 may be associated with a first numerical precision, and the first adjusted component 114a may be associated with a second numerical precision. The second numerical precision may be different from the first numerical precision.

In some aspects, adjusting the component associated with the AI model may include deactivating the component associated with the AI model, and processing the data associated with the AI model may include processing the data with the AI model with the deactivated component. For example, adjusting the first component 114 may include deactivating the first component 114.

In some aspects, deactivating the component associated with the AI model may include at least one of: suspending a service associated with the AI model or suspending a process associated with the AI model. For example, deactivating the first component 114 may include suspending a service associated with the AI model 112 or suspending a process associated with the AI model 112.

In some aspects, the component associated with the AI model may include at least one of: a preprocessing component of the AI model; a prompt engineering component of the AI model; or a training component of the AI model. For example, the first component 114 may be or include a preprocessing component of the AI model; a prompt engineering component of the AI model; and/or a training component of the AI model

[symbol]

In some aspects, the computing device may include an edge device. For example, the computing device 102 may be or include an edge device. In another example, the computing device may be or include the edge device 202.

In some aspects, the computing device may consume a first amount of power prior to the component associated with the AI model being adjusted, the computing device may consume a second amount of power subsequent to the component associated with the AI model being adjusted, and the first amount of power may be greater than the second amount of power. For example, the computing device 102 may consume a first amount of power prior to the first component 114 being adjusted and the computing device 102 may consume a second amount of power subsequent to the first component 114 being adjusted, where the first amount of power may be greater than the second amount of power.

In some aspects, the processing device may obtain a query for the AI model. For example, the input data 119 may be or include a query.

In some aspects, the processing device may classify a complexity of the query, where adjusting the component associated with the AI model may be further based on the complexity of the query, and where processing the data with the AI model with the adjusted component may include processing the query with the AI model with the adjusted component. For example, the processing device may classify a complexity of the input data 119, and the computing device 102 may just the first component 114 based on the complexity of the input data 119.

In some aspects, the operational parameters associated with the computing device may include at least one of: a battery level of the computing device; memory usage of the computing device; processor usage of the computing device; or historical usage patterns of the computing device. For example, the operational parameters 118 may be or include a battery level of the computing device; memory usage of the computing device; processor usage of the computing device; and/or historical usage patterns of the computing device.

In some aspects, the computing device may utilize a first amount of computational resources prior to the component associated with the AI model being adjusted, the computing device may utilize a second amount of computational resources subsequent to the component associated with the AI model being adjusted, and the first amount of computational resources may be greater than the second amount of computational resources. For example, the computing device 102 may consume a first amount of computational resources prior to the first component 114 being adjusted and the computing device 102 may consume a second amount of computational resources subsequent to the first component 114 being adjusted, where the first amount of computational resources may be greater than the second amount of computational resources.

In some aspects, the processing device may determine, subsequent to adjusting the component associated with the AI model, that functionality of the component associated with the AI model prior to the adjustment is to be utilized by the AI model. For example, after adjusting the first component 114 to be the first adjusted component 114a, the computing device 102 may determine that functionality associated with the first component 114 is to be utilized by the AI model 112.

In some aspects, the processing device may revert the adjustment of the component associated with the AI model based on the determination. For example, the computing device 102 may revert the first adjusted component 114a to be the first component 114.

In some aspects, determining that the functionality of the component associated with the AI model prior to the adjustment is to be utilized by the AI model may be based on at least one of: a battery level of the computing device; a complexity of a query to be processed by the AI model; or historical usage patterns of the computing device. For example, revering the first adjusted component 114a to be the first component 114 may be based on at least one of: a battery level of the computing device; a complexity of a query to be processed by the AI model; or historical usage patterns of the computing device.

In some aspects, the processing device may store state information associated with the component associated with the AI model prior to adjusting the component associated with the AI model, where reverting the adjustment of the component associated with the AI model may be based on the state information. For example, the state information may be or include the state information 128.

In some aspects, adjusting the component associated with the AI model may include adjusting the component associated with the AI model in view of a service level-agreement (SLA). For example, adjusting the first component 114 may be based on an SLA.

In some aspects, processing the data with the AI model with the adjusted component may include providing, as an input to the AI model with the adjusted component, the data and obtaining, as an output of the AI model with the adjusted component, a result. For example, the computing device 102 may provide, as an input to the AI model 112, the input data 119 and the computing device 102 may obtain, as an output of the AI model 112, the output data 120.

In some aspects, the processing device may determine a power consumption of the component associated with the AI model, where adjusting the component associated with the AI model may be based on the power consumption of the component associated with the AI model. For example, the computing device 102 may determine a power consumption of the first component 114, and adjusting the first component 114 may be based on the power consumption.

FIG. 5 illustrates a diagrammatic representation of a machine in the example form of a computer system 500 within which a set of instructions, for causing the machine to perform any one or more of the methodologies discussed herein for an adaptive hibernation mechanism for AI models on edge devices. More specifically, the machine may monitor operational parameters associated with a computing device on which an artificial intelligence (AI) model is deployed; adjust, by a processing device, a component associated with the AI model based on the monitored operational parameters; and process data with the AI model with the adjusted component

In alternative aspects, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or a bridge, a hub, an access point, a network access control device, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one aspect, the computer system 500 may be representative of a server.

The computer system 500 includes a processing device 502, a main memory 504 (e.g., read-only memory (ROM), flash memory, dynamic random access memory (DRAM), a static memory 506 (e.g., flash memory, static random access memory (SRAM), etc.), and a data storage device 518, which communicate with each other via a bus 530. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

The computer system 500 may further include a network interface device 508 which may communicate with a network 520. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 515 (e.g., a speaker). In one example, the video display unit 510, the alphanumeric input device 512, and the cursor control device 514 may be combined into a single component or device (e.g., an LCD touch screen).

The processing device 502 represents one or more general-purpose processing devices such as a microprocessor, a central processing unit, or the like. More particularly, the processing device 502 may be a complex instruction set computing (CISC) microprocessor, a reduced instruction set computer (RISC) microprocessor, a very long instruction word (VLIW) microprocessor, or a processor implementing other instruction sets, or processors implementing a combination of instruction sets. The processing device 502 may also be one or more special-purpose processing devices such as an application specific integrated circuit (ASIC), a field programmable gate array (FPGA), a digital signal processor (DSP), a network processor, or the like. The processing device 502 is configured with hibernation instructions 525, for performing the operations and steps discussed herein. For example, the hibernation instructions 525 may include instructions for monitoring operational parameters associated with a computing device on which an artificial intelligence (AI) model is deployed. The hibernation instructions 525 may include instructions for adjusting a component associated with the AI model based on the monitored operational parameters. The hibernation instructions 525 may include instructions for processing data with the AI model with the adjusted component.

The data storage device 518 may include a machine-readable storage medium 528 (e.g., a non-transitory computer-readable medium) storing hibernation instructions 525 (e.g., software) embodying any one or more of the methodologies of functions described herein. The hibernation instructions 525 may also reside, completely or partially, within the main memory 504 or within the processing device 502 during execution thereof by the computer system 500; the main memory 504 and the processing device 502 also constituting machine-readable storage media. The hibernation instructions 525 may further be transmitted or received over the network 520 via the network interface device 508.

The machine-readable storage medium 528 may also be used to store the hibernation instructions 525 to perform a method for an adaptive hibernation mechanism for AI models on edge devices, as described herein. While the machine-readable storage medium 528 is shown in an exemplary aspect to be a single medium, the term “machine-readable storage medium” should be taken to include a single medium or multiple media (e.g., a centralized or distributed database, or associated caches and servers) that store the one or more sets of instructions. A machine-readable storage medium includes any mechanism for storing information in a form (e.g., software, processing application) readable by a machine (e.g., a computer). The machine-readable storage medium may include, but is not limited to, a magnetic storage medium (e.g., floppy diskette), an optical storage medium (e.g., CD-ROM), a magneto-optical storage medium, a read-only memory (ROM), random-access memory (RAM), erasable programmable memory (e.g., EPROM and EEPROM), flash memory, or another type of medium suitable for storing electronic instructions.

The preceding description sets forth numerous specific details such as examples of specific systems, components, methods, and so forth, in order to provide a good understanding of several aspects of the present disclosure. It will be apparent to one skilled in the art, however, that at least some aspects of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular aspects may vary from these exemplary details and still be contemplated to be within the scope of the present disclosure.

Additionally, some aspects may be practiced in distributed computing environments where the machine-readable medium is stored on and or executed by more than one computer system. In addition, the information transferred between computer systems may either be pulled or pushed across the communication medium connecting the computer systems.

Aspects of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another aspect, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an aspect” or “one aspect” or “an implementation” or “one implementation” throughout is not intended to mean the same aspect or implementation unless described as such. Furthermore, the terms “first,” “second,” “third,” “fourth,” etc. as used herein are meant as labels to distinguish among different elements and may not necessarily have an ordinal meaning according to their numerical designation. Unless specifically stated otherwise, terms such as “monitoring,” “adjusting,” “processing,” “freezing,” “changing,” “updating,” “activating,” “deactivating,” “suspending,” “unsuspending,” “training,” “retraining,” “obtaining,” “classifying,” “determining,” “reverting,” “storing,” “providing,” “inputting,” “outputting,” “transmitting,” “receiving,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices.

It will be appreciated that variants of the above-disclosed and other features and functions, or alternatives thereof, may be combined into may other different systems or applications. Various presently unforeseen or unanticipated alternatives, modifications, variations, or improvements therein may be subsequently made by those skilled in the art which are also intended to be encompassed by the following claims. The claims may encompass aspects in hardware, software, or a combination thereof.

What is claimed is:

1. A method, comprising:
monitoring operational parameters associated with a computing device on which an artificial intelligence (AI) model is deployed;
adjusting, by a processing device, a component associated with the AI model based on the monitored operational parameters; and
processing data with the AI model with the adjusted component.

2. The method of claim 1, wherein the AI model comprises a plurality of layers, and wherein adjusting the component associated with the AI model comprises freezing a layer in the plurality of layers such that weights of the layer are not updated during a training process of the AI model.

3. The method of claim 1, wherein adjusting the component associated with the AI model comprises changing a numerical precision of the AI model from a first numerical precession to a second numerical precession, and wherein processing the data with the AI model comprises processing the data with the AI model using the second numerical precision.

4. The method of claim 1, wherein adjusting the component associated with the AI model comprises deactivating the component associated with the AI model, and wherein processing the data associated with the AI model comprises processing the data with the AI model with the deactivated component.

5. The method of claim 4, wherein deactivating the component associated with the AI model comprises at least one of:
suspending a service associated with the AI model; or
suspending a process associated with the AI model.

6. The method of claim 1, wherein the component associated with the AI model comprises at least one of:
a preprocessing component of the AI model;
a prompt engineering component of the AI model; or
a training component of the AI model.

7. The method of claim 1, wherein the computing device comprises an edge device.

8. The method of claim 1, wherein the computing device consumes a first amount of power prior to the component associated with the AI model being adjusted, wherein the computing device consumes a second amount of power subsequent to the component associated with the AI model being adjusted, and wherein the first amount of power is greater than the second amount of power.

9. The method of claim 1, further comprising:
obtaining a query for the AI model; and
classifying a complexity of the query, wherein adjusting the component associated with the AI model is further based on the complexity of the query, and wherein processing the data with the AI model with the adjusted component comprises processing the query with the AI model with the adjusted component.

10. The method of claim 1, wherein the operational parameters associated with the computing device comprise at least one of:
a battery level of the computing device;
memory usage of the computing device;
processor usage of the computing device; or
historical usage patterns of the computing device.

11. The method of claim 1, wherein the computing device utilizes a first amount of computational resources prior to the component associated with the AI model being adjusted, wherein the computing device utilizes a second amount of computational resources subsequent to the component associated with the AI model being adjusted, and wherein the first amount of computational resources is greater than the second amount of computational resources.

12. A system, comprising:
a memory; and
a processing device, operatively coupled to the memory, to:
monitor operational parameters associated with a computing device on which an artificial intelligence (AI) model is deployed;
adjust a component associated with the AI model based on the monitored operational parameters; and
process data with the AI model with the adjusted component.

13. The system of claim 12, wherein the processing device is further to:
determine, subsequent to the adjustment of the component associated with the AI model, that functionality of the component associated with the AI model prior to the adjustment is to be utilized by the AI model; and
revert the adjustment of the component associated with the AI model based on the determination.

14. The system of claim 13, wherein the determination that the functionality of the component associated with the AI model prior to the adjustment is to be utilized by the AI model is based on at least one of:
a battery level of the computing device;
a complexity of a query to be processed by the AI model; or
historical usage patterns of the computing device.

15. The system of claim 12, wherein the processing device is further to:
store state information associated with the component associated with the AI model prior to the adjustment of the component associated with the AI model, wherein to revert the adjustment of the component associated with the AI model, the processing device is to revert the adjustment of the component associated with the AI model based on the state information.

16. The system of claim 12, wherein to adjust the component associated with the AI model, the processing device is to adjust the component associated with the AI model in view of a service level-agreement (SLA).

17. A non-transitory computer-readable medium having instructions stored thereon which, when executed by a processing device, cause the processing device to:
monitor operational parameters associated with a computing device on which an artificial intelligence (AI) model is deployed;
adjust, by the processing device, a component associated with the AI model based on the monitored operational parameters; and
processing data with the AI model with the adjusted component.

18. The non-transitory computer-readable medium of claim 17, wherein to process the data with the AI model with the adjusted component, the instructions, when executed by the processing device, cause the processing device to:
provide, as an input to the AI model with the adjusted component, the data; and
obtain, as an output of the AI model with the adjusted component, a result.

19. The non-transitory computer-readable medium of claim 17, wherein the instructions, when executed by the processing device, cause the processing device further to:
determine a power consumption of the component associated with the AI model, wherein to adjust the component associated with the AI model, the instructions, when executed by the processing device, cause the processing device to adjust the component associated with the AI model based on the power consumption of the component associated with the AI model.

20. The non-transitory computer-readable medium of claim 17, wherein the operational parameters associated with the computing device comprise at least one of:
a battery level of the computing device;
memory usage of the computing device;
processor usage of the computing device; or
historical usage patterns of the computing device.
